(19) United States
(12) Patent Application Publication
(10) Pub. No.: US 2001/0048361 A1
(43) Pub. Date: Dec. 6, 2001

(54) Method and apparatus for providing interchangeability of RFID devices

(76) Inventors: Wesley M. Mays, Coppell, TX (US); Christopher A. Wiklof, Everett, WA (US)

Correspondence Address: CHRISTOPHER A. WIKLOF, 3531 99TH STREET, S.E., EVERETT, WA, 98208, US

(21) Appl. No.: 09/864,807

(22) Filed: May 24, 2001

Related U.S. Application Data
(60) Provisional application No. 60/209,406, filed on Jun. 1, 2000.

(51) Int. Cl. H04Q 5/22

(52) U.S. Cl. 340/10.51

(57) ABSTRACT

A method and apparatus enables interchangeability of radio frequency (RF) tags. A tag programmer may include a capability for communicating using a plurality of protocols. The tag programmer may further include a capability for communicating using a plurality of frequencies. Compatibility with a second type for RF tag may be accomplished via a plug-in module. The tag programmer may include an integral print engine. RF tags may be adapted to communication at 2 or more frequencies.

### CROSS REFERENCES TO RELATED APPLICATIONS

The present application depends from and claims priority from U.S. Provisional Patent Application number 60/209,406 entitled MULTIPLE FREQUENCY RFID DEVICE dated Jun. 1, 2000.

### TECHNICAL FIELD

The present invention is directed to the field of radio frequency identification and more particularly to the field of writing data to an RF tag using a radio interface.

### BACKGROUND OF THE INVENTION

In the field of radio frequency identification (RF ID), radio frequency tags (RF tags) are memory devices that may be interrogated via a radio interface. Some tags contained only fixed data and are called read-only tags. Other tags may be programmed with variable data and are called read/write tags.

Some RF tags use a backscatter interface. Backscatter tags operate as variable RF reflectors and communicate with an interrogator by altering the resonance properties of their antennas, typically by alternately making and breaking a connection between antenna elements. Variable resonance may be detected by an interrogator as a variation in backscatter or reflectance of an emitted signal. Some RF tags operate by transmitting on a second frequency, typically at a multiple or fraction of the interrogating frequency. Some RF tags operate in a half-duplex mode, absorbing and storing energy during emission by an interrogator and subsequently using the stored energy to transmit a message while the interrogator is quiet.

Active RF tags use batteries to power their transmitters. Passive RF tags extract power from an interrogation beam and use it to power their transmitters and, optionally, their micro-controllers. Some backscatter RF tags use batteries to power their electronics but use only beam power to communicate.

Often, manufacturers of RF tags aim to design tags to operate at one of several unlicensed frequencies or frequency bands. An unlicensed frequency is one that a radio frequency governance body such as the United States Federal Communications Commission (FCC) has designated for use and that does not require issuance of a broadcast license to operate on, provided power levels meet pre-determined guidelines. There are several such unlicensed frequency bands that may be used by RF tags in the United States, including 125 kilohertz (kHz), 13.56 megahertz (MHz), 915 MHz, and 2.45 gigahertz (GHz). These bands are sometimes called low frequency, very high frequency (VHF), ultrahigh frequency (UHF), and microwave, respectively.

In general, a given RF tag has a frequency band for which it is designed to operate. Often, especially for UHF and microwave tags, the RF tag antenna has its highest sensitivity or Q at the designed frequency band. High Q antennas may be desirable because they provide greater communications sensitivity, and hence, greater range than a comparable low Q antenna.

Another aspect of an RF tag's interface is its protocol. A protocol comprises the set of commands and responses used to communicate with and control an RF tag. It also comprises the type of bit encoding used. A wide variety of bit encoding schemas are used including amplitude modulation (AM), frequency modulation (FM), frequency shift keyed (FSK), phase shift keyed (PSK), and others.

Recent work in the art has been devoted to developing lower cost RF tags than have been previously available. One method for achieving lower cost in RF tags has been to modify the packaging of the tags. Whereas RF tags have formerly been available in relatively expensive injection molded packaging, some newer cost-reduced RF tags have been packaged by laminating them into lower cost pressure-sensitive labels. Pressure-sensitive labels with embedded RF tags have been termed smart labels or intelligent labels in the trade press.

In conjunction with the development of intelligent labels, work has been devoted to the development of a label printer that is capable of printing and programming intelligent labels. Conventional approaches to this problem have focused on designing an intelligent label printer/programmer for a specific type of RF tag. Thus each individual printer/programmer is compatible with a single type of intelligent label designed to receive data on a particular frequency using a particular protocol.

### SUMMARY OF THE INVENTION

One embodiment teaches a method and system for using RF tags that is flexible with respect to operating frequency and protocol.

Another aspect relates to a system for programming an RF tag at a first frequency and subsequently reading the RF tag at a second frequency.

Another aspect relates to a system for programming an RF tag at a first frequency and subsequently transmitting additional or replacement data to said RF tag at a second frequency.

Another aspect relates to an RF tag programmer having multi-frequency capability.

Another aspect relates to an RF tag programmer having multi-protocol capability.

Another embodiment teaches an RF tag designed to receive data on at least two different frequencies.

Another aspect relates to an RF tag having an antenna characterized by relatively high Q at two or more frequencies.

Another aspect relates to an RF tag having an antenna responsive to magnetic coupling and to plane wave coupling

Another aspect relates to an RF tag having an antenna responsive to magnetic coupling at a plurality of frequencies.

Another aspect relates to an RF tag having an antenna with a programming stub that adapts it to communication at a plurality of frequencies.

Another aspect relates to an intelligent label programmer/printer that is capable of being installed to program a first type of RF tag at a first frequency and later be conveniently adapted to program a second type of RF tag at a second frequency.

Various embodiments can enable programming an RF tag at a first frequency or protocol and later adding more data to the tag or reading data from the tag at a second frequency or protocol. This has utility, for instance, in cases where locations for a first instance of programming or reading, and the second instance for programming or reading differ. In such cases, different RF communications equipment installed at the locations may differ substantially, thus prohibiting communications at a consistent frequency or protocol. In other instances, local radio emissions rules or the presence of other radio emission sources or receivers may make it undesirable or even illegal to communicate at a consistent frequency or protocol. In other instances, embodiments can allow programming a first RF tag or batch of RF tags responsive to a first frequency and/or protocol, and subsequently programming a second RF tag or batch of RF tags responsive to a second frequency and/or protocol.

This may have utility, for instance, when the first tag or batch of tags is intended for use at a geographic location where it is desirable to operate at the first frequency or protocol, and the second tag or batch of tags is intended for subsequent use at a geographic location where it is desirable to operate at the second frequency or protocol. This may occur, for instance, when the first tag is to be affixed to a pallet destined for a first customer and the second tag is to be affixed to a pallet destined for a second customer. In this case, the first tag may, for instance, be responsive to a 915 MHz RFID system installed at the first customer's facility and the second tag responsive to a 13.56 MHz RFID system installed at the second customer's facility.

In another example, some embodiments may enable the use of multiple sources of RF tags with a particular RFID system. This can be especially advantageous if the user wishes to make use of different technologies in some instances because of performance differences between tags of differing manufacturers or for concerns of maintaining a source of supply during periods of supply shortages.

Some embodiments allow an RF tag to be programmed via radio frequency energy at frequencies that are not at the designed operational frequencies for that device. For example, a tag designed to operate at 2.45 GHz may be programmed at 915 MHz. Likewise, a tag designed for operation at 5.9 GHz may be programmed at 13.56 MHz or 125 kHz.

### BRIEF DESCRIPTION OF THE DRAWINGS

FIG. 1 is a block diagram of an apparatus for programming RF tags.

FIG. 2 is a block diagram of an apparatus having two selectable RF sources for programming RF tags at two or more frequencies FIG. 3 is a diagram of an embodiment comprising a main unit and a plug-in module for programming RF tags at two or more frequencies.

FIG. 4 illustrates an RF tag having an antenna adapted to communicate at a plurality of frequencies using a programming stub in addition to a high gain antenna element.

FIG. 5 illustrates an RF tag having an antenna adapted to communicate at a plurality of frequencies using a magnetic near-field coupling loop and higher frequency far field or plane wave antenna.

FIG. 6 illustrates an RF tag having a microwave or UHF sensitive antenna coupled to a lower frequency loop antenna via a converter circuit.

FIG. 7 is a block diagram of an intelligent label programmer/printer having an RF module for programming RF tags via an external near-contact antenna surface.

FIG. 8 is a block diagram of an intelligent label programmer/printer having an internal near-contact antenna for transmitting signals generated by an RF module.

### DETAILED DESCRIPTION OF THE INVENTION

A numbering convention to facilitate easy understanding by the reader is used herein. Figures are numbered in conventional consecutive order. Specific features are generally indexed consecutively using three or four digit numbers in the order described. The first one or two digits correspond to the figure number in which the feature is first described. Features having similar functionality generally retain their originally assigned number throughout, even though their physical or logical appearance may vary considerably from figure to figure.

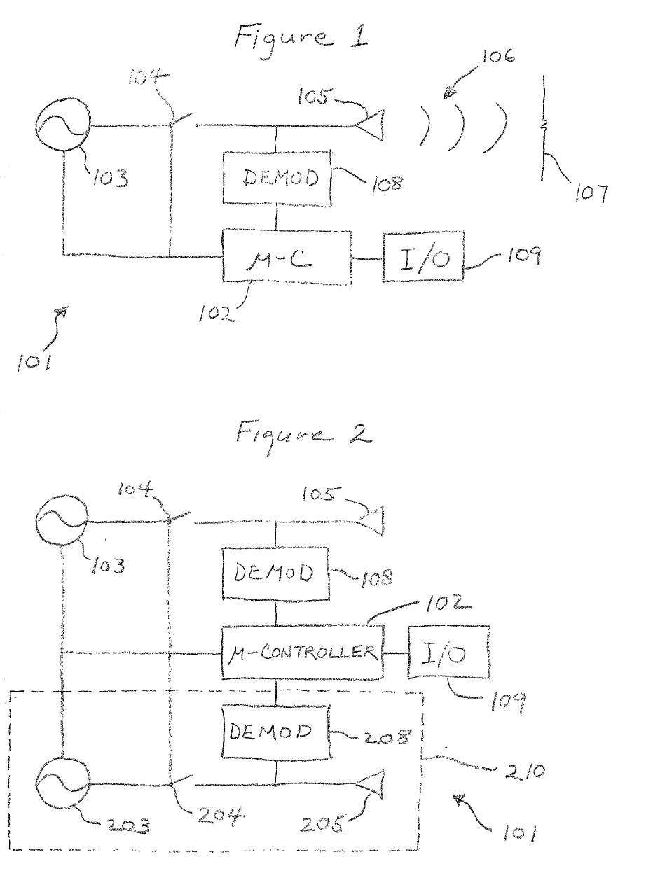

FIG. 1 is a block diagram of an RF tag programmer module 101 having a capability of programming and, optionally, reading RF tags having sensitivity at two or more frequencies. Micro-controller 102 may, for instance, be a conventional digital design having a microprocessor and memory for executing computer instructions. Micro-controller 102 may be coupled to external systems via input-output element 109. Micro-controller 102 controls RF source 103 and modulator 104 to transmit a radio frequency signal through antenna 105, creating interrogation beam 106. RF tag 107 may be disposed within interrogation beam 106. For the case of a backscatter system, RF tag 106 may vary its resonance characteristics in response to data transmitted from RF tag interrogator 101. An RF tag may use an embedded controller responsive to commands received via interrogation beam 106 to execute variation in resonance characteristics.

During operation, micro-controller 102 commands RF source 103 to generate radio frequency energy. Modulator 104 is commanded to alter signal transmission between RF source 103 and antenna 105 to create a modulated RF signal according to a defined communication protocol. Modulation schemas that may be implemented include AM, FM, FSK, PSK, and others.

RF tag 107 receives a modulated RF signal via interrogation beam 106. In response to received communications, RF tag 107 may execute operations including storing received data in memory, transmitting its identification, transmitting some or all of its stored data, transmitting its status, changing its status, locking data in memory, unlocking memory, executing arbitration activities, controlling external devices, selecting protocol, or other operations.

Execution of some commands may require transmission of data from RF tag 107 to antenna 105. In a backscatter system, this may be achieved by alternately modulating data and commands, and transmitting a continuous wave (CW) signal by closing modulator 104. Upon receipt of commands and subsequent illumination by a CW signal, RF tag 107 varies its resonance characteristics and in doing so, varies its apparent reflectivity to antenna 105. The modulated reflected bit pattern is converted to base band through demodulator 108 and the bit pattern interpreted by microcontroller 102. In this way, two-way communication between interrogator 101 and one or more RF tags 107 may be performed.

Data transmission protocols other than backscatter may also be executed by module 101 according to techniques known to the art and, optionally, using modifications to the block diagram of FIG. 1, as may be necessary. For instance, half-duplex communication may be executed by opening modulator 104 or, optionally, by turning RF source 103 off during periods of time when RF tag 107 is transmitting a signal. For communication with a full-duplex RF tag that receives data on a first frequency and transmits data on a second frequency, for instance, a receiver tuned to the response frequency may transmit the response signal to demodulator 108 or, alternatively, a receiver may be substituted for demodulator 108.

In some embodiments, RF source 103 may be capable of generating a plurality of radio frequencies. It may be advantageous to employ switchable antennas or antenna elements 105 tuned to two or more frequencies. Alternatively, a broad response (relatively low Q) antenna 105 may be used for communicating at the plurality of frequencies of RF source 103. In other embodiments, the system of FIG. 1 may use RF tags 107 that are adapted to communicate at a plurality of frequencies and hence adapt to a fixed frequency RF source 103.

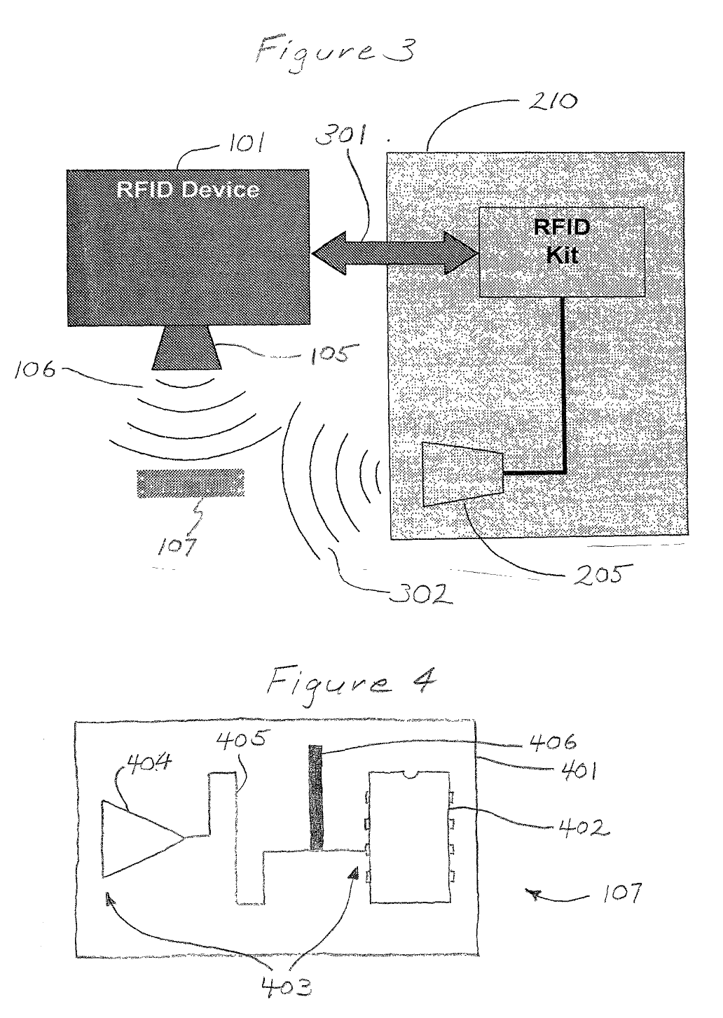

FIG. 2 is a block diagram of an embodiment having a plurality of selectable RF sources and, optionally, a plurality of modulators and antennas. FIG. 2 is drawn to an example having a second channel comprising a second set of RF source 203, modulator 204, and antenna 205. Additionally, this example includes a second demodulator 208 for demodulating a signal received via antenna 205 to base band. Optionally, the second channel may be implemented as a plugin module 210.

Other arrangements of plug-in module 210 may be used according to the designer's preference. For example, plug-in module 210 may comprise an RF source 203 that may connect so as to be modulated by modulator 104. Alternatively, plug-in module 210 may connect to first antenna 105. Alternatively, plug-in module 210 may be constructed omitting demodulator 208, connecting instead via demodulator 108. In other embodiments, demodulator 108 may comprise a different type of RF tuner known to the art. Alternatively, plug-in module 210 may include a microcontroller for controlling communications with RF tags.

Embodiments may enable the use of a plurality of tag protocols each, for instance, saved in memory of the programmer, to enable a particular frequency or protocol to be used for a particular tag. In this case, the programmer can modulate the programming signal with that code that unlocks the memory in the tag for programming.

FIG. 3 is a block diagram of an embodiment having a first RF tag programmer 101 operative to produce tag programming to an RF tag 107 via an 5 antenna 105 to produce a first communication field 106. Tag programmer 101 may also be operative to read RF tag 107.

Tag programmer 101 has an interface 301 for coupling to a second RFID module 210, operative via antenna 205 to produce a second communication field 302. Second communication field 302 may be operative to communicate with RF tag 107 or a second RF tag 107b (not shown).

In some embodiments, module 210 may comprise an RFID device compatible with a frequency or frequencies not compatible with RFID device 101.

In some embodiments where the RFID device 101 is capable only of reading RF tags, RFID module may comprise a programmer module for programming RF tags. In other embodiments, module 210 may be operative at substantially the same frequency or frequencies as RFID device 101, adding the capability of communicating with alternative tag protocols.

The RFID device 101 may comprise an RF module containing a transmitter, a receiver, decoder, and processor. The additive module 210 may comprise a transmitter, a receiver, decoder, and processor. The additive module may be connected to an energy-transmitting device, such as typified by an antenna or loop 205. The additive module may be connected to the internal data bus of the RFID device via interface 301 or may communicate through an external communication port.

In the case of using a specific protocol for each particular device, a desired or pre-designated device may be addressed. The protocol structure may, for instance, be linked to the frequency of operation of the programming device or to the RF tag being programmed.

FIG. 4 illustrates an embodiment of an RF tag 107 operative for far field reading at a first frequency and programmable at one or more additional frequencies. Substrate 401 provides support for an RF tag integrated circuit (IC) 402 and an antenna 403. Substrate 401 may be formed, for instance of a standard circuit board material such as FR4 or polyimide for instance, or may be formed integrally with a label material such as paper, polyester, biaxially-oriented polypropylene, vinyl, or other material as preferred by the designer. Antenna 403 may be formed, for instance by etching traces on the surface of the substrate, by printing conductive material, or by other known means.

RF tag 107 may be an active tag, or alternatively IC 402 may comprise a single-chip type of passive RF tag circuit. Such devices comprise means for extracting energy from an interrogation beam, optionally, means for storing energy received from the interrogation beam, a section for communications, a controller for responding to received commands, and memory for storing data. Energy extraction means may comprise one or more fast, high efficiency full-bridge rectifiers which may, for instance, charge a capacitor for storing information over a period of a few RF cycles. The capacitor or other energy storage means may then maintain a relatively constant voltage for operating the controller and the memory.

Antenna 403 may comprise a communications antenna element 404 and matching circuit 405. Additionally, antenna 403 may comprise a programming stub 406 constructed to communicate at a frequency different from the designed communication frequency of the communications element 404 and impedance matching circuit 405. In the example of FIG. 4, communications element 404 may comprise a horn antenna optimized for far field communications. Programming stub 406 may comprise an even fractional wavelength, λ/n antenna capable of communications at a programming wavelength. For example, if horn element 404 and matching circuit 405 are designed for operation at 915 MHz, programming stub may comprise a λ/4 antenna for communicating at 2.4 GHz spread spectrum. This arrangement would allow a programming device operative at 2.4 GHz to program RF tags nominally designed to operate at 915 MHz. Programming stub 406 may appear as an open circuit at the frequency of communications element 404.

In some embodiments, it may be desirable for the design of programming stub 406 to be somewhat different from a nominal free space λ/n antenna to accommodate near field effects and/or to accommodate the electromagnetic environment of the RF tag programming device.

Tags that operate with frequencies of resonance at relatively long wavelengths may preclude the use of a resonant antenna, instead using a magnetic coupling device such as embodied by a loop arrangement of a conductive material. The coupling method is considered to be in the near field, since the resonant wavelength is relatively long compared to the distance that the tag can communicate. This is commonly expressed as “magnetic coupling” similar to the effect seen in a transformer.

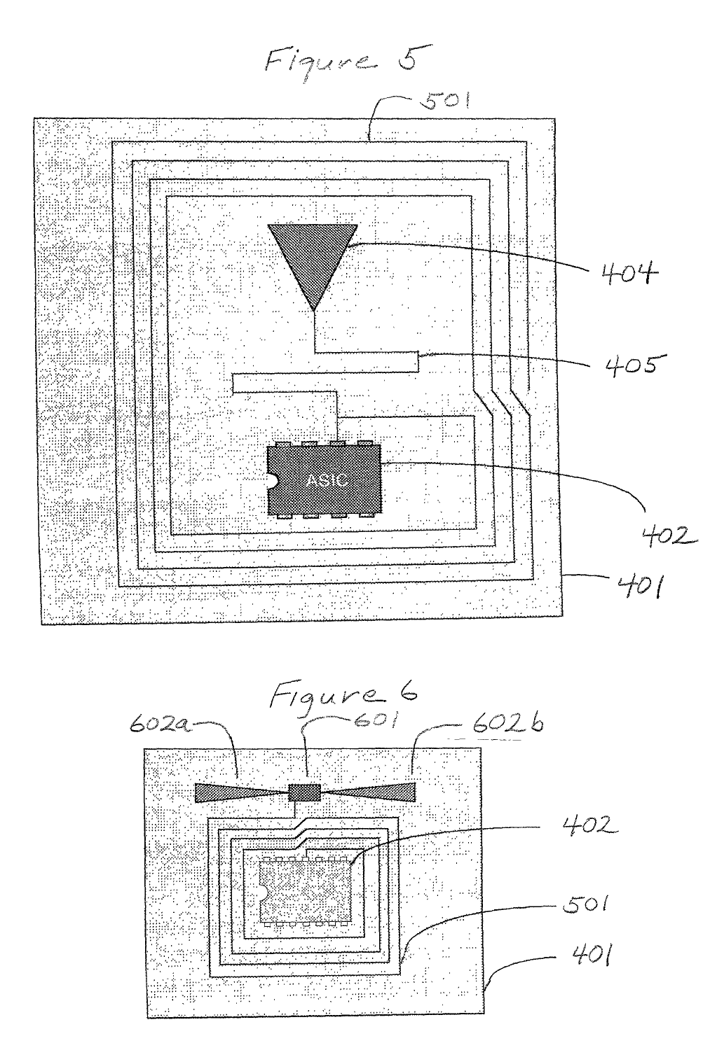

FIG. 5 illustrates an example of a multi-frequency RF tag having an antenna element optimized for use at a high frequency band, such as 13.56 MHz for instance, and a second antenna element optimized for use at a higher frequency for instance in the UHF or microwave regions. Such a second antenna element may comprise an ancillary circuit used for programming the tag or may comprise a high gain circuit for far field communication.

Substrate 401 supports an RFID IC 402 and UHF or microwave antenna elements 404 and 405 operative at 915 MHz or 2.4 GHz, for instance. In addition, loop antenna 501 may be coupled to provide communication at a high frequency band such as 13.56 MHz. As described above, the embodiment of loop antenna 501 shown in FIG. 5 is adapted to magnetic coupling.

Another example is to use a resonant antenna tag operating in the UHF or microwave range (915 or 2450 MHz) with an ancillary antenna or loop designed to allow the tag to be programmed with a programmer designed, for instance for operation in the VLF range such as at 125 kHz or in the HF region such as at 13.56 MHz. The loop of conductive material may operate at relatively long wavelengths that preclude the use of a plane wave or far field antenna owing to size constraints and may use magnetic coupling. Magnetic coupling is considered to be in the near field, since the resonant wavelength is relatively long compared to the distance that the tag can communicate.

FIG. 6 illustrates an RF tag embodiment that couples a very high frequency antenna comprising antenna elements 602a and 602b through a simple detector circuit 601 to resonant loop antenna 501. The very high frequency detector elements receive a UHF or microwave signal well out of the frequency range of the coupling loop 501. The detector 601 converts the signal to a lower frequency that can be used by the tag to communicate. In other embodiments, the converter 601 may be placed in proximity to coupling loop 501 with capacitive coupling providing the signal path from very high frequency elements 602a and 602b, through converter 601, through coupling loop 501, to RF IC 402.

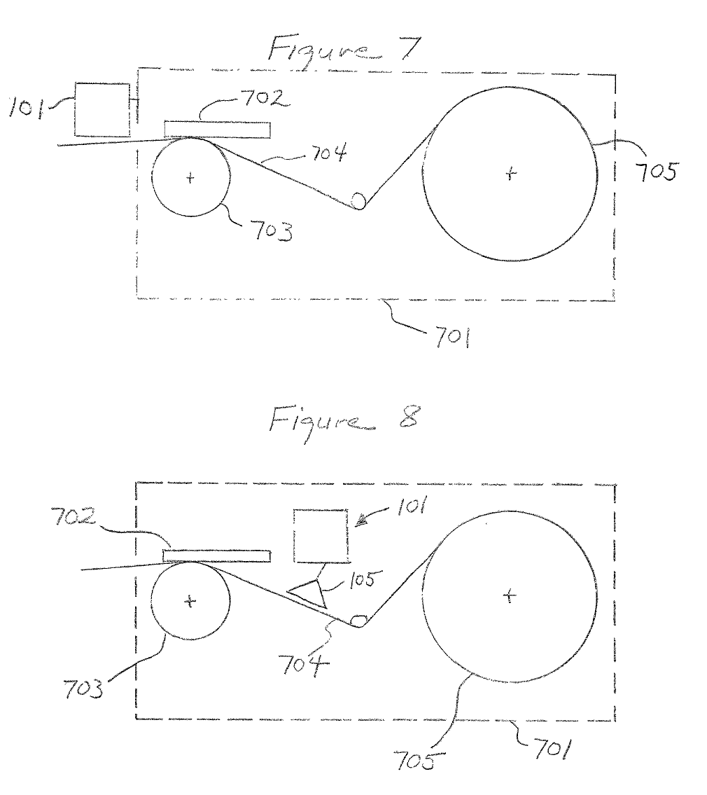

FIG. 7 is a block diagram of an intelligent label programmer/printer having capability to program RF tags. Frame 701 contains a print engine, here depicted as thermal printhead 702 and platen roller 703. The print engine may be capable of printing indicia such as human-readable printing, bar codes, and graphic images on the surface of intelligent labels. Other digital printing technologies may be used for the print engine including ink jet, electro-photographic, and dot matrix impact. Digital printing technologies may be particularly well adapted for on-demand, on-site production of intelligent labels. Alternatively, conventional printing press technologies such as, for instance, lithographic, gravure, letterpress, screen, or flexographic may be used. In this case, the intelligent label programmer/printer may comprise a centralized intelligent label production facility for off-site production of intelligent labels.

Intelligent labels are fed to the print engine as media web 704 from media supply 705. RF programmer 101 may be affixed external to frame 701 so as to present an interrogation and programming field to intelligent labels carried by media web 704. In some embodiments, programmer 101 may include portions of the electronics within frame 701 and other portions, for instance the antenna only, external to frame 701.

In some embodiments the external antenna may be kept in such close contact with the tags and driven with sufficient power to program even tags designed to operate at different frequencies than that at which the RF source operates. The use of RF tags having programming features such as those shown in FIGS. 4, 5, and 6 help reduce the amount of power and/or the required proximity. In a second embodiment, the RF source is able to drive the external antenna at a plurality of frequencies, at least two of said plurality of frequencies being appropriate for programming a type of RF tag.

FIG. 8 is a block diagram of an intelligent label programmer/printer having one or more internal antennas 105 for programming RF tags. In this case, a housing of the programmer/printer may be adapted to form a Faraday cage to contain emissions from the programming antenna. This form is well adapted for high power levels or for programming tags at a frequency not certified for unlicensed operation at the programmer/printer's installed location.

The preceding overview of the invention, brief description of the drawings, and detailed description describe exemplary embodiments of the present invention in a manner intended to foster ease of understanding by the reader. To achieve reasonable simplicity, many possible embodiments have been omitted. The scope of the invention described herein shall be limited only by the claims.

What is claimed is:

1. A method for using an RF tag, comprising the steps of; transmitting a first data set to a tag at a first frequency, and transmitting second data set to the tag at a second frequency.

2. The method of claim 1, wherein; the first data set comprises; a command for writing data, and data for storing in the tag.

3. The method of claim 1, wherein; the second data set comprises; a command for reading data from the tag.

4. The method of claim 3, further comprising the step of; reading data from the tag at the second frequency.

5. The method of claim 1, wherein; the first instance of transmitting data and the second instance of transmitting data occur a separate locations.

6. An RF tag programmer, comprising;
a digital controller,
a radio frequency source controlled by the digital controller,
a modulator controlled by the digital controller for modulating radio frequency energy generated by the radio frequency source, and
an antenna coupled to the output of the modulator for transmitting modulated radio frequency energy to an RF tag, whereby;
the RF tag programmer may transmit modulated radio frequency energy at a plurality of radio frequencies.

7. The RF tag programmer of claim 6, wherein; the RF source is tunable to a plurality of radio frequencies.

8. The RF tag programmer of claim 6, wherein; the RF source comprises a plurality of RF sources.

9. The RF tag programmer of claim 8, further comprising; a plurality of modulators coupled to the plurality of RF sources.

10. The RF tag programmer of claim 9, wherein; at least one of a set comprising a coupled RF source and modulator is installable as a module.

11. The RF tag programmer of claim 6, further comprising; a printer for producing printed indicia on the RF tag.

12. An RF tag, comprising;
a first digital controller,
a first radio frequency communication module coupled to the digital controller, and
a first antenna coupled to the radio frequency communication module,
whereby the RF tag may receive data at a plurality of radio frequencies.

13. The RF tag of claim 12, wherein; the digital controller and the radio frequency communication module are formed on a common silicon die.

14. The RF tag of claim 12, wherein; the RF tag is a passive RF tag.

15. The RF tag of claim 12, further comprising;
a label substrate for receiving printing,
the substrate also providing a surface for mounting the digital controller, the radio frequency communication module, and the antenna.

16. The RF tag of claim 12, further comprising;
a second radio frequency communication module coupled to the first digital controller, and
a second antenna coupled to the second radio frequency communication module.

17. The RF tag of claim 12, further comprising;
a second digital controller,
a second radio frequency communication module coupled to the second digital controller, and
a second antenna coupled to the second radio frequency communication module.

18. The RF tag of claim 12, wherein; the antenna comprises;
a first section responsive to magnetic coupling, and
a second section responsive to carrier wave coupling.

19. The RF tag of claim 12, wherein; the antenna comprises;
a first section responsive to near field coupling, and
a second section responsive to far field coupling.

20. The RF tag of claim 12, wherein;
the antenna comprises; a data transmission element, and a programming stub.

21. The RF tag of claim 12, wherein; the antenna comprises;
a first element responsive to a first frequency, and
a second element responsive to a second frequency.

22. The RF tag of claim 21, further comprising
a conversion circuit coupled between the first antenna element and the second antenna element, whereby;
the conversion circuit converts the second frequency to the first frequency.

23. An apparatus for printing and programming intelligent labels, comprising;
a print engine having a media path, and
an RF tag programmer mounted thereto,
whereby media comprising intelligent labels may be programmed and printed with indicia, and wherein;
the RF tag programmer is capable of transmitting RF energy at a plurality of frequencies.

24. The apparatus of claim 23, wherein; the print engine is a thermal transfer print engine.

25. The apparatus of claim 23, wherein; the print engine is a flexographic printing press.

26. The apparatus of claim 23, further comprising; a media supply for holding a length of intelligent labels prior to printing.

27. A method for writing data to RF tags, comprising;
programming one or more of a first set of RF tags in a programmer,
removing a media supply of the first set of RF tags from the programmer,
installing a second set of RF tags in the programmer, and
programming at least one of the second set of RF tags, wherein;
the first set and second set of RF tags use different communication interfaces.

28. The method of claim 27, wherein;
the first set of RF tags uses a first communication protocol, and
the second set of RF tags uses a second communication protocol.

29. The method of claim 27, wherein;
the first set of RF tags uses a first communication frequency, and
the second set of RF tags uses a second communication frequency.

30. The method of claim 27, further comprising; printing indicia on a surface of said first one or more RF tags with a print engine.

31. The method of claim 30, wherein; the print engine comprises a thermal print engine.

32. The method of claim 30, wherein; the print engine comprises a flexographic printing press.

33. The method of claim 27, wherein; switching the programmer from the first communication interface to the second communication interface happens substantially without overt user intervention.
